(19) United States
(12) Patent Application Publication
(10) Pub. No.: US 2004/0189711 A1
(43) Pub. Date: Sep. 30, 2004

(54) Object display device, object display method and computer program product

(75) Inventor: Makoto Misawa, Kawasaki (JP)

Correspondence Address: STAAS & HALSEY LLP, SUITE 700, 1201 NEW YORK AVENUE, N.W., WASHINGTON, DC, 20005, US

(73) Assignee: Fujitsu Limited, Kawasaki (JP)

(21) Appl. No.: 10/766,859

(22) Filed: Jan. 30, 2004

(30) Foreign Application Priority Data
Mar. 28, 2003 (JP) 2003-092574

(51) Int. Cl. G09G 5/00

(52) U.S. Cl. 345/790

(57) ABSTRACT

An object display device includes a visibility determining unit and an appearance changing unit. The visibility determining unit determines whether a first object to be handled on a screen hides a second object that has been displayed on the screen. The appearance changing unit changes, depending on determination by the visibility determining unit, appearance of the first object so that the second object becomes visible.

### BACKGROUND OF THE INVENTION

1) Field of the Invention

The present invention relates to an object display device that adds or moves an object having a predetermined appearance to a screen on which the other object has been displayed, to display the object. More specifically, the present invention relates to such an object display device that a user can efficiently operate even when the object is added or moved in the screen.

2) Description of the Related Art

Object display devices, which add or move an object having a predetermined appearance to a screen on which the other object has been displayed, have been used (for example, see Japanese Patent Application Laid-Open No. H09-167249). More specifically, as shown in FIG. 2A, such a conventional object display device sequentially adds or moves additional/movable objects 22 and 23 in a base object 21 to display the objects.

However, it is difficult for the user to efficiently operate the conventional object display device when an object is added or moved in a screen on which the other object is displayed. For instance, when the additional/movable objects 22 and 23 are added or moved in the screen, the conventional object display device requires a complex operation for the user to handle the base object 21. The complex operation includes, for example, changing the display sequence or the properties, of the additional/movable objects 22 and 23.

### SUMMARY OF THE INVENTION

It is an object of the present invention to at least solve the problems in the conventional technology.

An object display device according to one aspect of the present invention includes a visibility determining unit that determines whether a first object to be handled on a screen hides a second object that has been displayed on the screen; and an appearance changing unit that changes, depending on determination by the visibility determining unit, appearance of the first object so that the second object becomes visible.

An object display method according to another aspect of the present invention includes determining whether a first object to be handled on a screen hides a second object that has been displayed on the screen; and changing appearance of the first object so that the second object becomes visible when the first object hides the second object.

The computer program product according to still another aspect of the present invention realizes the method according to the present invention on a computer.

The other objects, features and advantages of the present invention are specifically set forth in or will become apparent from the following detailed descriptions of the invention when read in conjunction with the accompanying drawings.

### BRIEF DESCRIPTION OF THE DRAWINGS

FIG. 1 is a block diagram of an object display device according to a first embodiment of the present invention;

FIG. 2 is a sample screen that is output on the output unit;

FIG. 3 is a flow chart showing the process steps of the object display device according to the first embodiment;

FIG. 4 is a drawing illustrating the structure of a computer system according to a second embodiment of the present invention; and

FIG. 5 is a block diagram of the main unit of the computer system shown in FIG. 4.

### DETAILED DESCRIPTION

Exemplary embodiments of the object display device, an object display method, and a computer program product according to the present invention will be explained next with reference to the accompanying drawings.

An object display device and an object display method of a first embodiment will be explained first, and then a computer system that executes a computer program product for displaying object according to a second embodiment will be explained. Finally, various modifications of the present invention will be explained.

In the first embodiment, the object display device (object display method) according will be explained below. An overview and main features of the object display device according to the first embodiment will be explained first followed by an explanation of the structure of the object display device. After that, the steps of each process of the object display device will be explained.

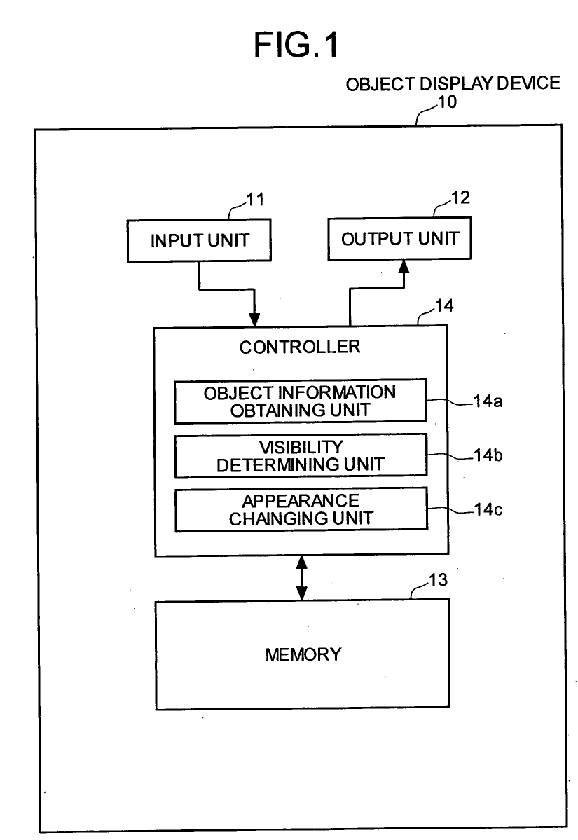

The overview and main features of the object display device according to the first embodiment of the present invention will be explained here. FIG. 1 is a block diagram of the object display device according to the first embodiment. The object display device 10 adds or moves an object having a predetermined appearance in a screen on which the other object has been displayed, to display the object.

The main feature of this object display device 10 is an object display process. The object display process includes, when the existing object on the screen is hidden by adding or moving an object to the screen, changing the object added or moved in such a way that the existing object becomes visible. The object display process allows a user to efficiently handle objects even when an object is added or moved to the screen on which the other object has been displayed.

To explain this main feature more specifically, the object display process determines, based on the position, size and/or color of the added or moved object and the existing object, whether the existing object is hidden. If it is determined that the existing object is hidden, the object display process changes the appearance of the added or moved object into semi-transparent in order to simplify complex processes which include for example changing the sequence of display or properties of the added or moved object.

Thus, due to the simplification of such complex processes, the user can efficiently handle objects even when an object is added or moved in the screen having the existing object.

In addition to the object display process, the object display device 10 according to the present embodiment has another feature which allows the object display device 10 to alter the transparency of the added or moved object in accordance with the state of overlapping of plural existing objects, when the existing objects are hidden. In other words, this feature allows the object display device 10 to optimize the visibility of the existing objects in accordance with the state of their overlapping.

Further, in the object display device 10 according to the present invention, the transparency of the added or moved object is altered in accordance with the number of colors of the existing object, when the existing object is hidden. In other words, the object display device 10 optimizes the visibility of the existing objects in accordance with the number of colors of the existing object.

The structure of the object display device 10 according to the first embodiment will be explained next. As shown in FIG. 1, the object display device 10 includes an input unit 11, an output unit 12, a memory 13, and a controller 14.

The input unit 11 is a means by which various data are entered, and is for example a keyboard, mouse or a track ball. More specifically, the input unit 11 receives instructions of adding or moving an object in the screen.

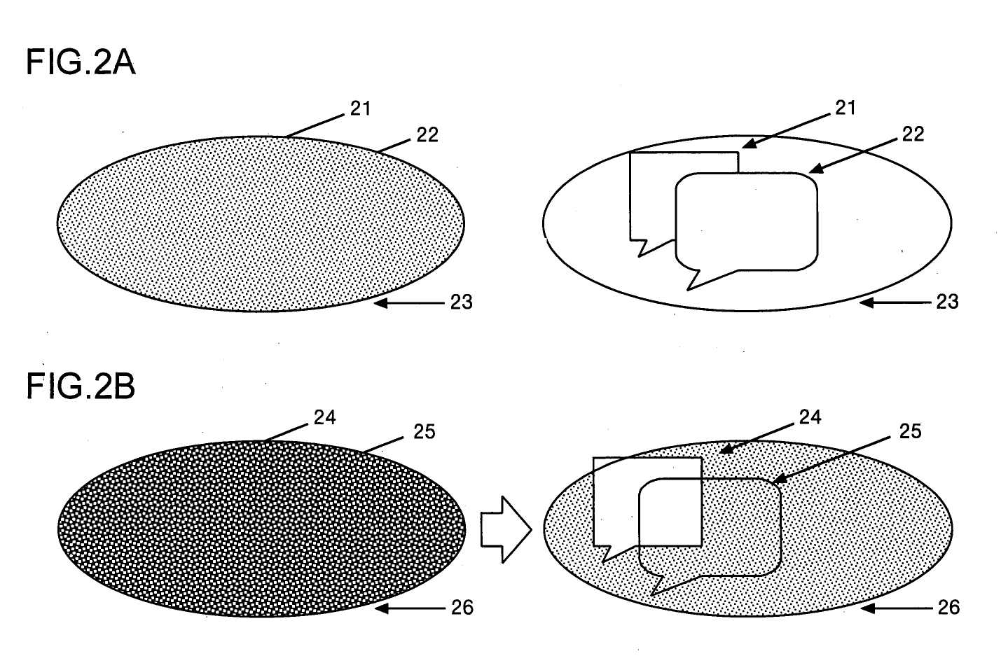

The output unit 12 is a means on which various data are output. More specifically, the output unit 12 displays the result (see FIG. 2B) of the processes carried out by an object information obtaining section 14a, a visibility determining section 14b, and an appearance changing section 14c, which are included in the controller 14.

The memory 13 is a storage unit which stores data and programs necessary for the processes of the controller 14. More specifically, the memory 13 stores programs that reproduce objects and data which form the source from which objects are generated.

The controller 14 has an internal memory for storing control programs (e.g. the operating system), programs for regulating various processes, and the required data. With the help of these programs and data, the controller 14 carries out various processes. Particularly, in the context of the present invention, the controller 14 includes the object information obtaining section 14a, visibility determining section 14b, and appearance changing section 14c.

The object information obtaining section 14a obtains the position, size and/or color of the added or moved object and the existing object. More specifically, the object information obtaining section 14a obtains the upper left coordinate point and the lengths along X-axis and Y-axis of the added or moved object. When the visibility determining section 14b determines that an object already exists, the object information obtaining section 14a obtains information concerning the existing object, such as the upper left coordinate point, the lengths along X-axis and Y-axis, color, and presence or absence of text.

The visibility determining section 14b determines whether the existing object is hidden by the added or moved object. More specifically, the visibility determining section 14b determines, based on the information concerning the added or moved object (the upper left coordinate point, lengths along X-axis and Y-axis) and the information concerning the existing object (upper left coordinate point, lengths along X-axis and Y-axis, object color, and presence or absence of text) obtained by the object information obtaining section 14a, whether the existing object is hidden or not.

The appearance changing section 14c changes, upon determination by the visibility determining section 14c that the existing object is hidden by the added or moved object, the appearance of the added or moved object in such a way that the existing object becomes visible. More specifically, the appearance changing section 14c changes the appearance of the added or moved object in such a way that the object becomes semi-transparent so that the complex processes of changing the sequence of display or properties etc. of the added or moved object can be simplified to a considerable extent (see FIG. 2B).

In other words, if the overlapping area is large or the number of overlapping portions is high, in order to make the existing object clearly visible to the user, the appearance changing section 14c lowers the transparency value of the added or moved object. If the brightness and color difference of the existing object is low, the appearance changing section 14c again reduces the transparency value of the added or moved object in order that the existing object is clearly visible.

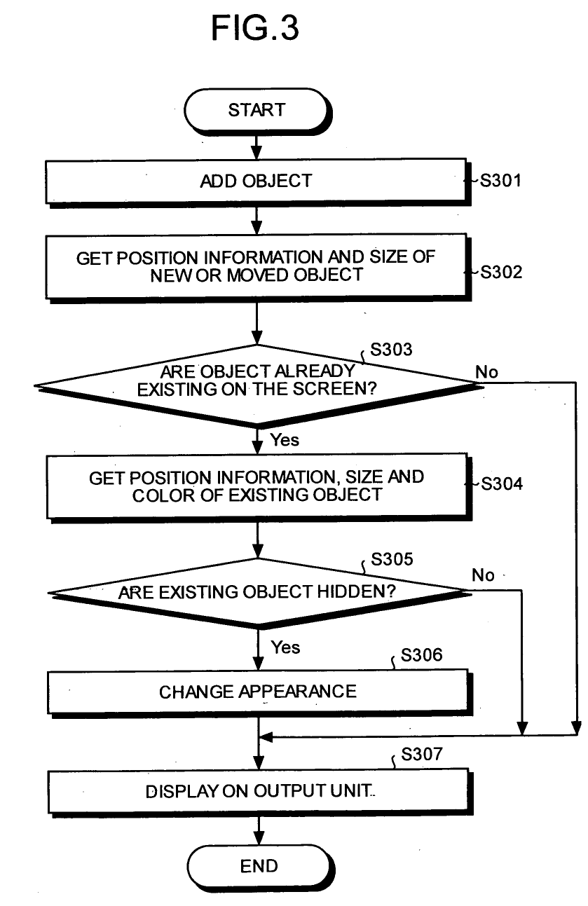

FIG. 3 is a flow chart illustrating the process steps of the object display device according to the first embodiment. The input unit 11 receives the instructions of adding an object to the screen (step S301).

Next, the object information obtaining section 14a obtains the upper left coordinate point, and the lengths along X-axis and Y-axis of the added or moved object 26 (step S302). Upon determination by the visibility determining section 14b that there is an existing object in the screen (step S303), the object information obtaining section 14a obtains information pertaining to the existing objects 24 and 25, such as the upper left coordinate points, the length along X-axis and Y-axis, color, presence or absence of text (step S304).

Next, the visibility determining section 14b determines, based on the information concerning the added or moved object 26 (upper left coordinate point, lengths along X-axis and Y-axis) and the existing object (upper left coordinate point, lengths along X-axis and Y-axis, color of the objects, and presence or absence of text) obtained by the object information obtaining section 14a, whether the existing objects 24 and 25 are hidden (step S305).

If the visibility determining section 14b determines that the existing objects 24 and 25 are hidden (“Yes” at step S305), the appearance changing section 14c changes the transparency of the added or moved object 26 such that it becomes semi-transparent and considerably simplifies the complex processes of changing the sequence of display or properties of the added or moved object 26 (step S306). The appearance changing section 14c then displays the objects on the output unit 12 (step S307). More specifically, if the overlapping area is large or the number of overlapping portions is high, in order to make the existing object clearly visible to the user, the appearance changing section 14c lowers the transparency value of the added or moved object. Similarly, if the brightness and color difference of the existing object is low, the appearance changing section 14c again reduces the transparency value of the added or moved object in order that the existing object is clearly visible.

If the visibility determining section 14b determines that the existing objects are visible (“No” at step S305), the objects are output to the output unit 12 (step S307). More specifically, if the existing objects and the added and moved object do not overlap or even if they do overlap, the properties of the added or moved object is changed, and the objects are output to the output unit 12 as they are.

Thus, in the object display device according to the first embodiment, the user can efficiently handle the objects on a screen has the existing objects even when objects are added or moved to the screen.

In the object display device according to the present embodiment, the visibility of the existing objects can be optimized in accordance with the state of their overlapping.

In the object display device according to the present embodiment, the visibility of the existing objects can be optimized in accordance with the number of colors.

The object display device and the object display method explained in the first embodiment can be realized by executing programs pre-installed in a computer system such as a personal computer or a workstation. A computer system that executes programs that perform functions similar to those of the object display device (object display method) explained in the first embodiment will be explained next.

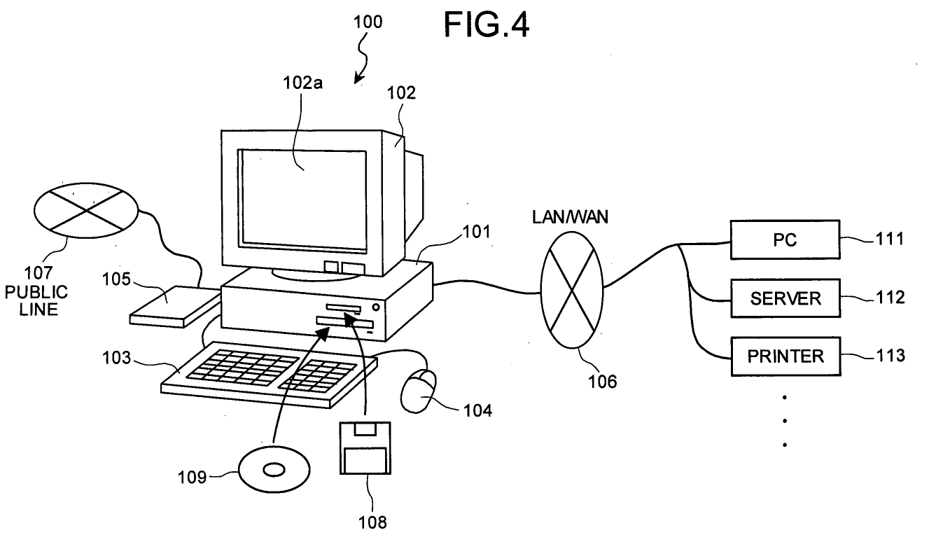

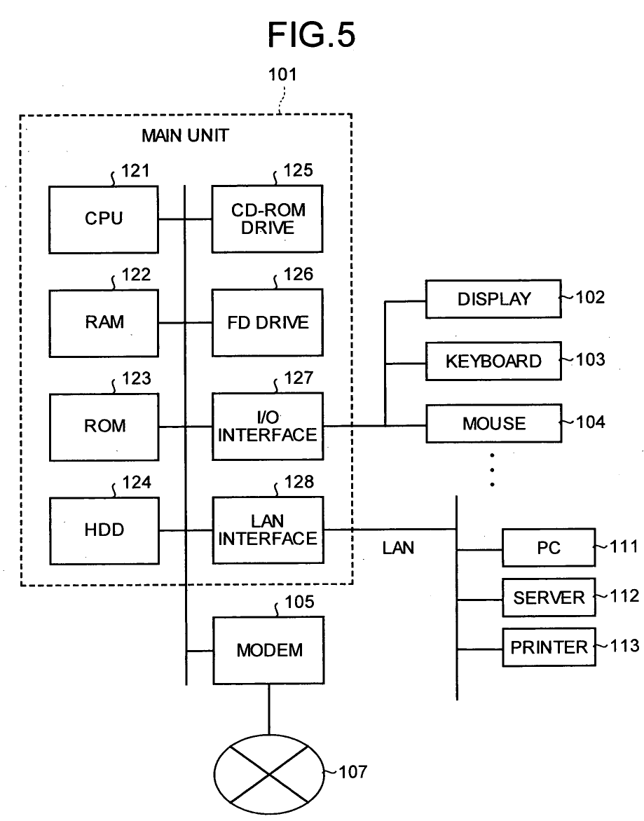

FIG. 4 shows a structure of the computer system according to the second embodiment of the present invention. FIG. 5 is a block diagram of the main unit of the computer system shown in FIG. 4. The computer system 100 according to the second embodiment of the present invention includes a main unit 101, a display 102 that displays data such as images on a display screen 102a in accordance with the instructions from the main unit 101, a keyboard 103 for inputting data into the computer system 100, and a mouse 104 for pointing to any item on the display screen 102a of the display 102.

The main unit 101 of the computer system 100 includes, a central processing unit 102, a RAM 122, a ROM 123, a hard disk drive (HDD) 124, a CD-ROM drive 125 that receives a CD-ROM109, a flexible disk (FD) drive 126 that receives a FD 108, an I/O interface 127 that connects the display 102, the keyboard 103, and the mouse 104, and a LAN interface 128 that connects to a local area network or a wide area network (LAN/WAN) 106.

A modem 105 is connected to the computer system 100 for connecting to a public line 107 such as the Internet. Another computer system (PC) 111, a server 112, and a printer 113 are connected to the computer system 100 via the LAN interface 128 and the LAN/WAN 106.

The computer system 100 realizes the functions of the object display device (object display method) by reading and executing the programs recorded in a specific recording medium. The recording medium may include a portabletype in the form of FD 108, CD-ROM 109, MO disk, DVD disk, magneto optic disk, IC card, etc., or a ‘fixed’ type in the form of HDD 124 integral to the computer system 100, RAM 122, ROM 123, etc, or a ‘communication medium’ in the form of public circuit 107 connected through the modem 105 or LAN/WAN 106 by which the computer system 100 is connected to another computer system 111 and the server 112 and which stores the transmitted program for a short duration.

In other words, the programs that make the computer realize the object display device and the object display method are stored in the portable medium, fixed medium or communication medium described above in a readable manner, and the computer system 100 executes these programs by reading the programs stored in the recording medium. Apart from the computer system 100, the programs for object display can also be executed by another computer system 111 or the server 112 or jointly by another computer system 111 and the server 112.

Although the invention has been described with respect to a specific embodiment, the appended claims are not to be thus limited but are to be construed as embodying all modifications and alternative constructions that may occur to one skilled in the art which fairly fall within the basic teaching herein set forth.

In other words, all the automatic processes explained in the present embodiment can be entirely or in part carried out manually. Similarly, all the manual processes explained in the present embodiment can be entirely or in part carried out automatically. The sequence of processes, the sequence of controls, specific names, and data including various parameters (e.g. transparency value) can be altered as required unless otherwise specified.

The constituent elements of the device illustrated are merely conceptual and may not necessarily physically resemble the structures shown in the drawings. For instance, the object display device need not necessarily have the structure that is illustrated. The device as a whole or in part can be broken down or integrated either functionally or physically in accordance with the load or how the device is to be used.

According to the present invention, it is determined whether existing objects on a screen become hidden upon adding or moving an object to the screen. If the existing objects are hidden, the appearance of the added or moved object is altered in order to make the existing objects visible. Consequently, an object display device is obtained that allows the user to efficiently handle the objects even when an object is added or moved in a screen having the existing object.

According to the present invention, it is determined whether the existing objects are hidden based on the position, size, and/or color of the added object or moved object, and the existing objects. Consequently, an object display device is obtained that gives an accurate information about the visibility of objects in the screen.

According to the present invention, if the existing objects are hidden, the appearance of the added object or moved object is changed into semi-transparent. Consequently, an object display device is obtained that makes the existing objects beneath the added object or moved object visible and allows the user to efficiently handle the objects.

According to the present invention, the transparency of the added object or moved object is altered in accordance with the state of overlapping of plural existing objects. Consequently, an object display device is obtained that optimizes the visibility of the existing objects.

According to the present invention, the transparency of the added object or moved object is altered in accordance with the number of colors of the existing objects. Consequently, an object display device is obtained that optimizes the visibility of the existing objects.

Although the invention has been described with respect to a specific embodiment for a complete and clear disclosure, the appended claims are not to be thus limited but are to be construed as embodying all modifications and alternative constructions that may occur to one skilled in the art which fairly fall within the basic teaching herein set forth.

What is claimed is:

1. An object display device comprising:
a visibility determining unit that determines whether a first object to be handled on a screen hides a second object that has been displayed on the screen; and
an appearance changing unit that changes, depending on determination by the visibility determining unit, appearance of the first object so that the second object becomes visible.

2. The object display device according to claim 1, wherein the first object is added in the screen.

3. The object display device according to claim 1, wherein the first object is moved on the screen.

4. The object display device according to claim 1, wherein the visibility determining unit determines whether the first object hides the second object, based on at least one of a position, size, and color, of the first object and the second object.

5. The object display device according to claim 1, wherein the appearance changing unit changes, when the visibility determining unit determines that the first object hides the second object, the appearance of the first object into semi-transparent.

6. The object display device according to claim 1, wherein the second object includes a plurality of existing objects, and
the appearance changing unit alters transparency of the first object depending on a state of overlapping of the existing objects.

7. The object display device according to claim 1, wherein the appearance changing unit alters transparency of the first object depending on color of the second object.

8. An object display method comprising:
determining whether a first object to be handled on a screen hides a second object that has been displayed on the screen; and
changing appearance of the first object so that the second object becomes visible when the first object hides the second object.

9. A computer program product for displaying an object on a screen, including computer executable instructions stored on a computer readable medium, wherein the instructions, when executed by the computer, cause the computer to perform:
determining whether a first object to be handled on the screen hides a second object that has been displayed on the screen; and
changing appearance of the first object so that the second object becomes visible when the first object hides the second object.
